(19) United States
(12) Patent Application Publication
(10) Pub. No.: US 2026/0257398 A1
(43) Pub. Date: Sep. 3, 2026

(54) METHOD AND APPARATUS FOR LAYER-BY-LAYER INKJET PRINTING OF CERAMIC MATERIAL

(71) Applicant: Hangzhou Pugen Intelligent Technology Co., Ltd., Hangzhou (CN)

(72) Inventors: Guojun ZHANG, Hangzhou (CN); Congyi WU, Hangzhou (CN); Yu HUANG, Hangzhou (CN); Youmin RONG, Hangzhou (CN); Mingzhou CHEN, Hangzhou (CN); Junfei DU, Hangzhou (CN); Qin XIE, Hangzhou (CN); Wenqiang WU, Hangzhou (CN)

(73) Assignee: Hangzhou Pugen Intelligent Technology Co., Ltd., Hangzhou (CN)

(21) Appl. No.: 19/554,523

(22) Filed: Mar. 2, 2026

(30) Foreign Application Priority Data
Mar. 3, 2025 (CN) 202510240230.3

(51) Int. Cl. B28B 11/08; B28B 1/00; B28B 17/00; B33Y 10/00; B33Y 30/00; B33Y 40/20; B33Y 50/02; G01C 3/02

(52) U.S. Cl. CPC B28B 11/0845; B28B 1/001; B28B 11/0872; B28B 17/0081; B33Y 10/00; B33Y 30/00; B33Y 40/20; B33Y 50/02; G01C 3/02

(57) ABSTRACT

A method for layer-by-layer inkjet printing of a ceramic material includes the following steps: printing a first layer of a ceramic green body, and heating the first layer of a ceramic green body to achieve preliminary shaping; scanning an upper surface morphology of the heated ceramic green body and comparing the upper surface morphology with an ideal model; correcting and microstructurally engraving an upper surface of the ceramic green body according to comparison results such that hydrophilicity and roughness of the ceramic green body approach hydrophilicity and roughness of the ideal model; repeating the above steps, and sequentially printing the ceramic green body from bottom to top until a completed ceramic green body is obtained; removing a water-soluble support material on a surface of the ceramic green body; and sintering the ceramic green body to obtain a finished ceramic component.

### CROSS-REFERENCE TO RELATED APPLICATIONS

The present application claims priority to Chinese Patent Application No. 202510240230.3, filed on March 3, 2025, which is hereby incorporated by reference in its entirety.

### TECHNICAL FIELD

The present disclosure relates to the technical field of ceramic additive manufacturing, and in particular to a method and apparatus for layer-by-layer inkjet printing of a ceramic material.

### BACKGROUND

Customized production of high-precision, multi-material complex ceramic components is widely applied to the fields such as aerospace, mechanical manufacturing, and biomedicine. Additive manufacturing technology is an effective approach for the customized production of complex ceramic components. Ceramic inkjet printing is widely applied in the production of ceramic components due to the characteristics of high molding precision and ability to produce multi-material components.

Currently, ceramic additive manufacturing by inkjet printing has the following drawbacks.

Firstly, an amount and uniformity of inkjet during the printing process cannot be accurately controlled, and as layers of additive manufacturing by inkjet printing increase, cumulative errors in the amount of inkjet increase, such that a dimensional error in a height direction increases. Furthermore, due to an uneven amount of inkjet at each position, a shape error of an upper surface of a ceramic green body increases after accumulation.

Secondly, a surface microstructure obtained by ceramic inkjet deposition in additive manufacturing by inkjet printing is difficult to control, thereby having an adverse effect on the strength and density of ceramic components manufactured additively by inkjet printing.

### SUMMARY

Based on this, it is necessary to provide a method and apparatus for layer-by-layer inkjet printing of a ceramic material to overcome the defects mentioned in the above background art.

A method for layer-by-layer inkjet printing of a ceramic material includes the following steps:

step 1: printing a first layer of a ceramic green body, and heating the first layer of a ceramic green body to achieve preliminary shaping;

step 2: scanning an upper surface morphology of the heated ceramic green body and comparing the upper surface morphology with an ideal model;

step 3: correcting and microstructurally engraving an upper surface of the ceramic green body according to comparison results such that hydrophilicity and roughness of the ceramic green body approach hydrophilicity and roughness of the ideal model;

step 4: repeating the steps 1 to 3, and sequentially printing the ceramic green body from bottom to top until a completed ceramic green body is obtained;

step 5: removing a water-soluble support material on a surface of the ceramic green body; and

step 6: sintering the ceramic green body to obtain a finished ceramic component.

As a preferred embodiment of the method for layer-by-layer inkjet printing of a ceramic material in the present disclosure, the step 3 specifically includes:

moving the ceramic green body to a laser processing position, and controlling a galvanometer and an external optical path to correct and microstructurally engrave the upper surface of the ceramic green body according to the comparison results in the step 2;

the correcting specifically includes:

comparing an actual height of a top surface of a current printing layer with a theoretical height, where when the actual height is less than the theoretical height, a difference between the two heights is recorded and compensated by increasing the number of printing layers; and when the actual height is greater than the theoretical height, ablating a top of the ceramic green body according to preset laser processing parameters to remove an excess protruding portion at the top of the ceramic green body;

the microstructurally engraving includes:

to enhance the structural strength of the ceramic component, using an infrared picosecond laser to scan parallel lines perpendicular to an extending direction of ridges and grooves on the upper surface of the ceramic green body, such that a scale-like structure appears on the upper surface of the ceramic green body; and

to reduce surface roughness of the ceramic component, using an infrared picosecond laser to repeatedly scan the ridges until all the ridges are completely removed.

As a preferred embodiment of the method for layer-by-layer inkjet printing of a ceramic material in the present disclosure, a single scale-like protrusion in the scale-like structure has a length of about 50 μm, a width of about 40 μm, and a height of about 20 μm.

As a preferred embodiment of the method for layer-by-layer inkjet printing of a ceramic material in the present disclosure, the step 5 specifically includes:

soaking the ceramic green body in pure water for 1 h to remove the water-soluble support material, and performing natural drying after standing in air for 3 h.

An apparatus for implementing the method for layer-by-layer inkjet printing of a ceramic material includes a main mounting frame, a two-dimensional motion platform is disposed at a lower part of the main mounting frame in an axial direction, and an upper part of the main mounting frame is provided with an inkjet printing module, a heating lamp module, a detection module, and a laser module that are sequentially arranged in the axial direction of the main mounting frame, further including a host computer configured to regulate and control the two-dimensional motion platform, the inkjet printing module, the heating lamp module, the detection module, and the laser module.

As a preferred embodiment of the apparatus in the present disclosure, a workbench is disposed at a top of the two-dimensional motion platform, including a bracket, where the bracket is fixedly connected to the two-dimensional motion platform, and a heat insulation layer and a manufacturing substrate are disposed at a top of the bracket.

As a preferred embodiment of the apparatus in the present disclosure, the inkjet printing module includes a motion Y-axis mounting frame fixedly connected to the main mounting frame, a motion Y-axis hanging basket slidably connected to the motion Y-axis mounting frame is disposed below the motion Y-axis mounting frame, and the motion Y-axis hanging basket is provided with an inkjet printhead.

As a preferred embodiment of the apparatus in the present disclosure, the heating lamp module includes a heating lamp mounting frame fixedly connected to the main mounting frame, and a heating lamp is disposed on the heating lamp mounting frame.

As a preferred embodiment of the apparatus in the present disclosure, the detection module includes a detection head mounting frame fixedly connected to the main mounting frame, and a laser triangulation detection head is disposed on the detection head mounting frame, and is connected to the host computer through an external signal processing module.

As a preferred embodiment of the apparatus in the present disclosure, the laser module includes a galvanometer mounting frame fixedly connected to the main mounting frame, a galvanometer is disposed on the galvanometer mounting frame, and a light inlet of the galvanometer communicates with the external optical path and is connected to the host computer through an external processing module.

The present disclosure has the following beneficial effects.

The present disclosure combines the technology of additive manufacturing by inkjet printing with the technology of subtractive manufacturing by laser processing, and corrects a cumulative height error during the additive manufacturing process and modifies a surface microstructure of a deposition surface, thereby improving the manufacturing precision and quality of ceramic parts.

### BRIEF DESCRIPTION OF THE DRAWINGS

In order to more clearly describe the technical solutions in the embodiments of the present disclosure or in the prior art, a brief introduction to the accompanying drawings required for the description of the embodiments or the prior art will be made below. Apparently, the accompanying drawings in the following description are merely some embodiments of the present disclosure, and those of ordinary skill in the art would also be able to derive other drawings from these drawings without making creative efforts.

FIG. 1 is a first schematic structural diagram of an apparatus in an embodiment of the present disclosure.

FIG. 2 is a second schematic structural diagram of an apparatus in an embodiment of the present disclosure.

FIG. 3 is a first schematic structural diagram of an inkjet printing module in an embodiment of the present disclosure.

FIG. 4 is a second schematic structural diagram of an inkjet printing module in an embodiment of the present disclosure.

FIG. 5 is a schematic structural diagram of an inkjet printing module in operation according to an embodiment of the present disclosure.

FIG. 6 is a schematic structural diagram of a heating lamp module in operation according to an embodiment of the present disclosure.

FIG. 7 is a schematic structural diagram of a detection module in operation according to an embodiment of the present disclosure.

FIG. 8 is a schematic structural diagram of a laser module in operation according to an embodiment of the present disclosure.

FIG. 9 is schematic flowchart of a method for layer-by-layer inkjet printing of a ceramic material in an embodiment of the present disclosure.

### DETAILED DESCRIPTION OF THE EMBODIMENTS

In order to enable the objectives, features, and advantages mentioned above of the present disclosure to be more apparent and easily understood, specific embodiments of the present disclosure will be described in detail below with reference to the accompanying drawings. Numerous specific details are set forth in the following description to facilitate a thorough understanding of the present disclosure. However, the present disclosure may be implemented in many other ways than those described herein, and those skilled in the art may make similar improvements without departing from the connotation of the present disclosure. Therefore, the present disclosure is not limited by the specific embodiments disclosed below.

In the description of the present disclosure, it should be understood that the terms "center", "longitudinal", "lateral", "length", "width", "thickness", "upper", "lower", "front", " rear", "left", "right", "vertical", "horizontal", "top", "bottom", "inner", "outer", "clockwise", "counterclockwise", "axial", “radial", “circumferential”, etc. indicate azimuthal or positional relations based on those shown in the accompanying drawings only for ease of description of the present disclosure and for simplicity of description, and are not intended to indicate or imply that the referenced device or element must have a particular orientation and be constructed and operative in a particular orientation, and thus may not be interpreted as a limitation on the present disclosure.

Furthermore, the terms "first" and "second" are merely for the purpose of description, and cannot be construed as indicating or implying relative importance or implicitly specifying the number of technical features indicated. Thus, a feature defined with "first" and "second" may explicitly or implicitly include at least one of the features. In the description of the present disclosure, “a plurality of” means at least two, such as two and three, unless expressly specified otherwise.

In the present disclosure, unless otherwise expressly specified and limited, the terms "mounted", "connected", "connecting", "fixed" and other terms should be understood in a broad sense. For example, it may be a fixed connection or a detachable connection or integration; it may be a mechanical connection or an electrical connection; it may be a direct connection or an indirect connection via an intermediate medium; and it may be internal communication or interaction between two elements, unless otherwise expressly limited. For those of ordinary skill in the art, the specific meanings of the above terms in the present disclosure may be understood according to specific circumstances.

In the present disclosure, unless otherwise expressly stated and defined, a first feature being "above" or "below" a second feature may refer to that the first feature and the second feature are in direct contact, or the first feature and the second feature are in indirect contact via an intermedium. In addition, the first feature being "over", "above" and "at the top of" the second feature may refer to that the first feature is over or above the second feature, or simply means that the level of the first feature is higher than that of the second feature. The first feature being "under", "below" and "at the bottom of" the second feature may refer to that the first feature is under or below the second feature, or simply means that the level of the first feature is lower than that of the second feature.

It should be noted that when an element is stated to be "fixed to" or "disposed on" another element, the element may be directly located on another element or there maybe exists a centered element. When an element is considered to be "connected" to another element, the element may be directly connected to another element or there maybe exists a centered element simultaneously. The terms "vertical", "horizontal", "upper", "lower", "left", "right", and similar expressions used herein are for illustrative purposes only and do not represent the sole embodiments.

In this embodiment, a method for layer-by-layer inkjet printing of a ceramic material is provided, and an apparatus for implementing the above method for layer-by-layer inkjet printing of a ceramic material is further provided, to overcome the defects of large cumulative error and poor strength and density of ceramic additive manufacturing by inkjet printing in the prior art.

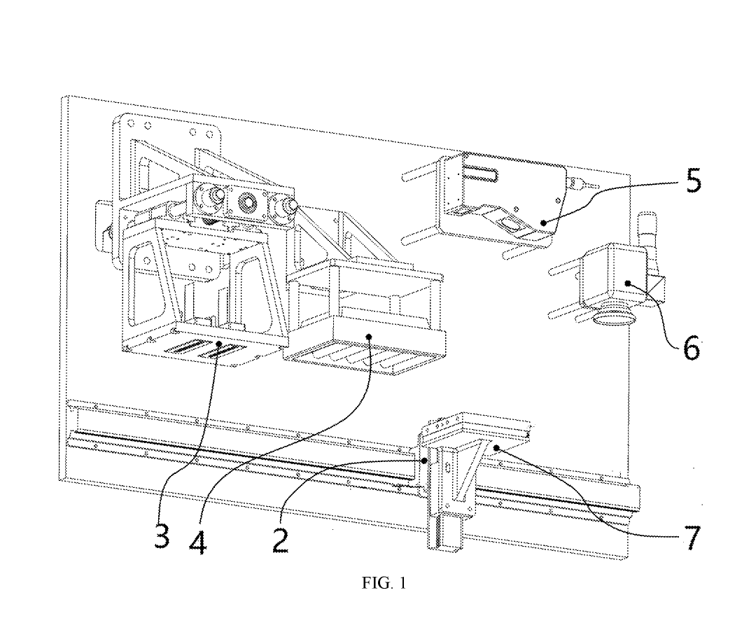

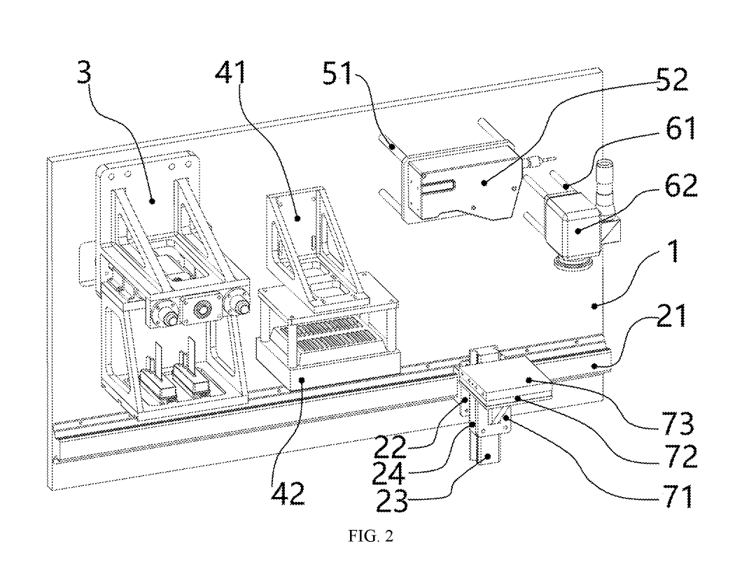

As shown in FIGS. 1 and 2, the apparatus includes a main mounting frame 1, a two-dimensional motion platform 2 is disposed at a lower part of one side of the main mounting frame 1, and an upper part of the main mounting frame 1 is provided with an inkjet printing module 3, a heating lamp module 4, a detection module 5, and a laser module 6 that are sequentially arranged in an axial direction of the main mounting frame. A workbench 7 slidable in an axial direction of the two-dimensional motion platform is disposed on the two-dimensional motion platform 2.

The workbench 7 includes a bracket 71 and is connected to the two-dimensional motion platform 2 through the bracket 71, a heat insulation layer 72 and a manufacturing substrate 73 are sequentially disposed at a top of the bracket 71 from bottom to top, and holes are processed in the manufacturing substrate 73 and configured to install a heating rod and a thermocouple that are capable of achieving heating and temperature control of the manufacturing substrate 73.

The two-dimensional motion platform 2 includes a motion X-axis 21, one end of the motion X-axis is fixedly connected to the main mounting frame 1, and a motion X-axis slider 22 is slidably connected to the other end of the motion X-axis. A motion Z-axis 23 is fixedly connected to an end of the motion X-axis slider 22 away from the motion X-axis 21, the motion Z-axis 23 is connected to the bracket 71 through a motion Z-axis slider 24 slidably connected to the motion Z-axis, and the workbench 7 slides in X-axis and Z-axis directions of the main mounting frame 1 under the driving action of the two-dimensional motion platform 2.

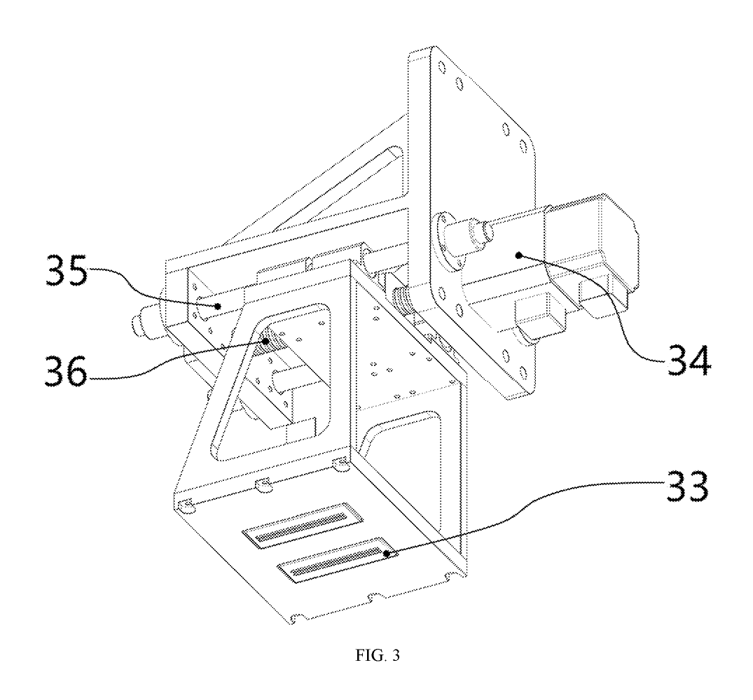

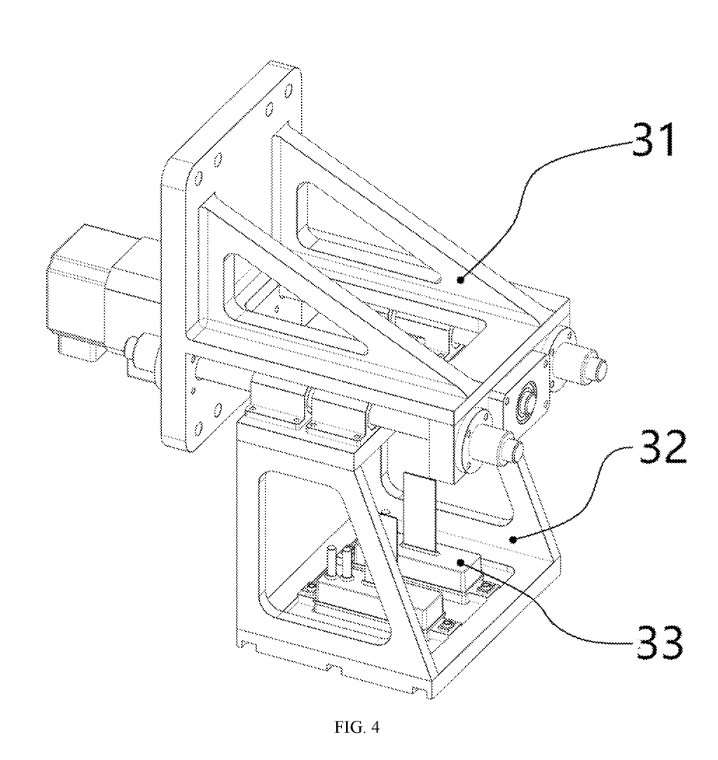

As shown in FIGS. 3 and 4, the inkjet printing module 3 includes a motion Y-axis mounting frame 31 and a motion Y-axis hanging basket 32 and is fixed on the main mounting frame 1, a motion Y-axis motor 34 is disposed on the motion Y-axis mounting frame 31, and a lead screw 36 is disposed at an output end of the motion Y-axis motor, where the lead screw 36 rotates under the driving action of the motion Y-axis motor 34, and guide rods 35 are disposed on both sides of the lead screw 36; and the motion Y-axis hanging basket 32 is slidably connected to the guide rods 35 through a sliding bearing, and is further threadedly connected to the lead screw 36, and the motion Y-axis hanging basket 32 translates along the guide rods 35 under the rotational action of the lead screw 36. The motion Y-axis hanging basket 32 is provided with inkjet printheads 33, an ink inlet and an ink outlet of either of the inkjet printheads 33 are connected to an external ink channel, one of the inkjet printheads 33 sprays ceramic ink, the other of the inkjet printheads 33 sprays water-soluble support material ink, and a control line of the inkjet printhead 33 is connected to a host computer through an external control board.

The heating lamp module 4 includes a heating lamp mounting frame 41 fixedly connected to the main mounting frame 1, and a heating lamp 42 is disposed on the heating lamp mounting frame 41.

The detection module 5 includes a detection head mounting frame 51 fixedly connected to the main mounting frame 1, and a laser triangulation detection head 52 is disposed on the detection head mounting frame 51, and is connected to the host computer through an external signal processing module.

The laser module 6 includes a galvanometer mounting frame 61 fixedly connected to the main mounting frame 1, a galvanometer 62 is disposed on the galvanometer mounting frame 61, and a light inlet of the galvanometer 62 communicates with the external optical path and is connected to the host computer through an external processing module.

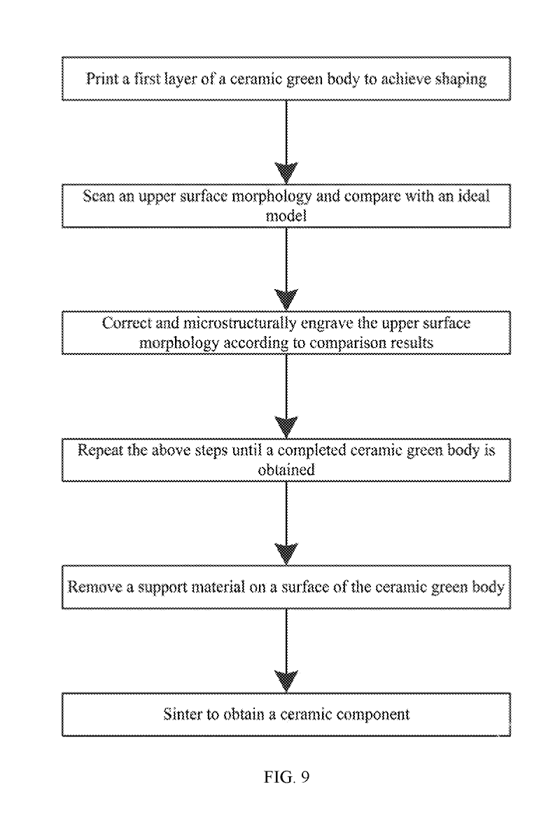

A method for layer-by-layer inkjet printing of a ceramic material, as shown in FIG. 9, includes the following steps:

S1: The manufacturing substrate 73 is heated to 170°C, the external ink channel supplies ink to the inkjet printheads 33, and the laser triangulation detection head 52 and the galvanometer 62 perform power-on self-tests.

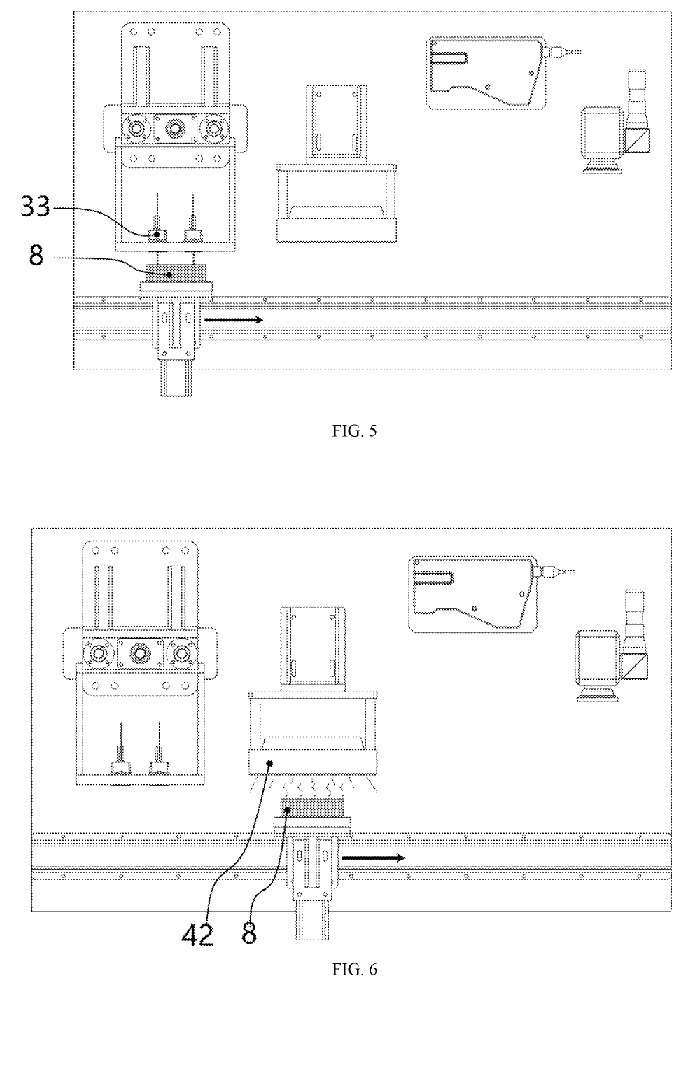

S2: Through the movement of the two-dimensional motion platform 2 and the motion Y-axis hanging basket 32 of the inkjet printing module 3, the workbench 7 and the inkjet printheads 33 are moved to an initial position of inkjet printing as shown in FIG. 5, the motion X-axis 21 drives the workbench 7 to translate at a constant speed, and the inkjet printhead 33 performs selective inkjet printing when the workbench 7 moves to an appropriate position until the workbench 7 moves to a termination position of inkjet printing.

S3: The two-dimensional motion platform 2 moves the workbench 7 to an initial position of heating as shown in FIG. 6, the heating lamp 42 is turned on, the motion X-axis 21 drives the workbench 7 to translate at a constant speed until the workbench 7 moves to a termination position of heating, and the heating lamp 42 is turned off.

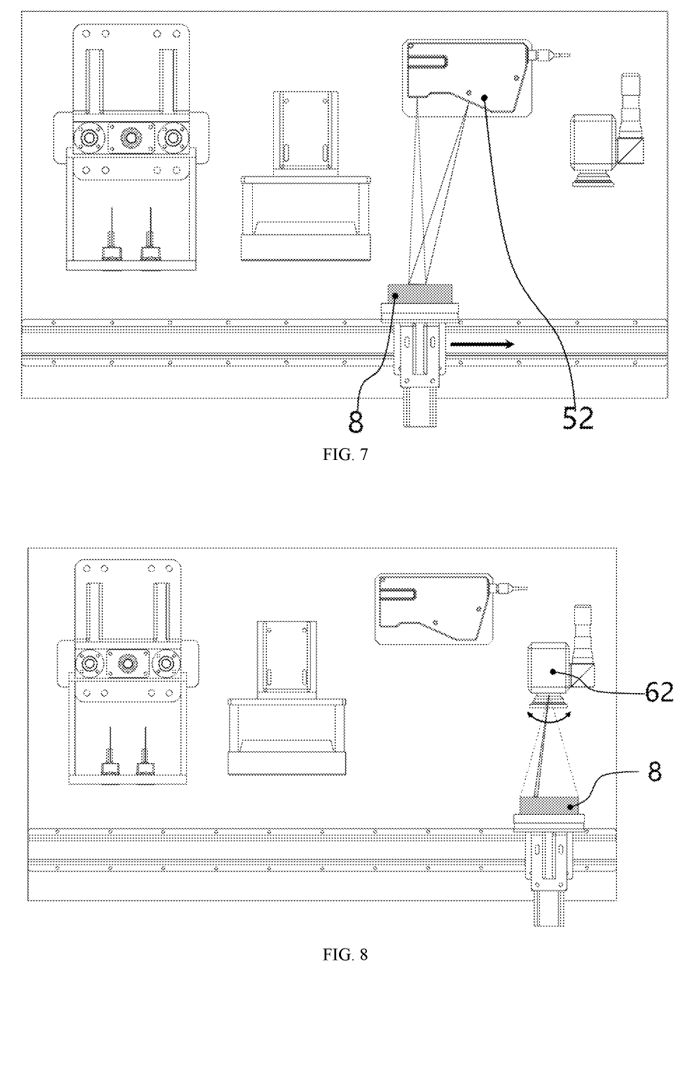

S4: The two-dimensional motion platform 2 moves the workbench 7 to an initial position of detection as shown in FIG. 7, the laser triangulation detection head 52 is activated, the motion X-axis 21 drives the workbench 7 to translate at a constant speed, and simultaneously, the laser triangulation detection head 52 scans an upper surface morphology of the ceramic green body 8 and performs modeling in the host computer until the workbench 7 moves to a termination position of detection, and the laser triangulation detection head 52 stops scanning.

S5: The two-dimensional motion platform 2 moves the workbench 7 to a position of laser processing as shown in FIG. 8, and the host computer controls the galvanometer 62 and the external optical path to correct and microstructurally engrave the upper surface of the ceramic green body 8 according to results of comparing the upper surface morphology of the ceramic green body 8 measured in the S4 with an ideal model. In an actual processing process, common results of testing the upper surface morphology of the ceramic green body 8 in the S4 are as follows: periodic ridges and grooves extending parallel to a motion axis X direction appear on the upper surface of the ceramic green body, a peak-to-peak height difference is 20 μm, a peak-to-peak distance is 50 μm, and in this case, laser processing parameters are set according to process requirements.

The correcting specifically includes:

comparing an actual height of a top surface of a current printing layer with a theoretical height, where when the actual height is less than the theoretical height, a difference between the two heights is recorded and compensated by increasing the number of printing layers; and when the actual height is greater than the theoretical height, ablating a top of the ceramic green body according to preset laser processing parameters to remove an excess protruding portion at the top of the ceramic green body.

The microstructurally engraving includes:

to enhance the structural strength of a printed part, an infrared picosecond laser (with a wavelength of 1,035 nm, and a frequency of 1,800 kHz) with 40% power is used to scan parallel lines perpendicular to an extending direction of the ridges and grooves (i.e., parallel to a motion axis Y direction) at a speed of 1,200 mm/s and a spacing of 40 μm, and scanning is repeated twice along the same path, where a scale-like structure appears on the upper surface of the ceramic green body, and a single scale-like protrusion in the scale-like structure has a length of 50 μm, a width of 40 μm, and a height of 20 μm, which enhances the hydrophilicity of the upper surface of the ceramic green body, and facilitates the subsequent deposition of ceramic particles in ink, thereby enhancing the structural strength.

To reduce surface roughness of the printed part, an infrared picosecond laser (with a wavelength of 1,035 nm, and a frequency of 1,800 kHz) with 40% power is used to scan the ridges at a speed of 1,200 mm/s, 10 μm of green body material is removed during scanning each time, and scanning is repeated until all the ridges are completely removed.

To reduce surface roughness of the printed part, the following steps are implemented:

S6: The steps S2, S3, S4, and S5 are repeated, and layer-by-layer inkjet printing of the ceramic green body 8 is performed from bottom to top, followed by correction and microstructural engraving until a complete ceramic green body 8 is obtained.

S7: The ceramic green body 8 obtained in the S6 is soaked in pure water (with a conductivity < 20 μS/cm) for 1 h to remove the water-soluble support material, and then natural drying is performed after standing in air for 3 h.

S8: The ceramic green body 8 with a support removed and obtained in the S7 is placed in a programmable high-temperature sintering furnace for sintering, a temperature is raised from 25°C to 250°C at a heating rate of 4°C/min, and the temperature keeps at 250°C for 2 h; the temperature is raised to 350°C at the same heating rate and kept for 3 h; the temperature is raised to 450°C at the same heating rate and kept for 3 h; then the temperature is raised to 800°C at a heating rate of 3°C/min for pre-sintering, and kept for 3.6 h; and finally the temperature is raised to 1,450°C at a heating rate of 3°C/min for sintering, and after holding for 9 h, the temperature is reduced to room temperature at a cooling speed of 3°C/min to obtain a finished ceramic component.

In this embodiment, for the ceramic green body 8 with a volume of less than 0.5 cm³ or a maximum cross-sectional thickness of less than 2 mm, holding time of each stage in the sintering process is shortened by 30% to improve the operation efficiency on the premise of ensuring quality; and for larger parts or parts with thicker walls, the heating rate should be appropriately reduced and the holding time should be prolonged to ensure the component quality.

The technical features of the above embodiments can be combined arbitrarily. For the sake of brevity, all possible combinations of the technical features in the above embodiments are not described. However, as long as the combinations of these technical features are not contradicted, it should be regarded as the scope of the description in this specification.

The embodiments mentioned above are merely several embodiments of the present disclosure, and are specifically described in details, but may not be interpreted as limiting the scope of the patent for the present disclosure as a result. It should be noted that for those of ordinary skill in the art, they may also make several transformations and improvements on the premise of not deviating from the conception of the present disclosure, and these transformations and improvements shall fall within the scope of protection of the present disclosure. The scope of protection of the present patent for disclosure shall be governed by the appended claim.

1. A method for layer-by-layer inkjet printing of a ceramic material, comprising the following steps:
step 1: printing a first layer of a ceramic green body, and heating the first layer of a ceramic green body to achieve preliminary shaping;
step 2: scanning an upper surface morphology of the heated ceramic green body and comparing the upper surface morphology with an ideal model;
step 3: correcting and microstructurally engraving an upper surface of the ceramic green body according to comparison results such that hydrophilicity and roughness of the ceramic green body approach hydrophilicity and roughness of the ideal model; wherein
the correcting comprises:
comparing an actual height of a top surface of a current printing layer with a theoretical height, wherein when the actual height is less than the theoretical height, a difference between the two heights is recorded and compensated by increasing the number of printing layers; and when the actual height is greater than the theoretical height, ablating a top of the green body according to preset laser processing parameters to remove an excess protruding portion on the top of the green body;
the microstructurally engraving comprises:
to enhance structural strength of a ceramic component, using an infrared picosecond laser to scan parallel lines perpendicular to an extending direction of ridges and grooves on the upper surface of the ceramic green body, such that a scale-like structure appears on the upper surface of the ceramic green body; and
to reduce surface roughness of the ceramic component, using an infrared picosecond laser to repeatedly scan the ridges until all the ridges are completely removed;
step 4: repeating the steps 1 to 3, and sequentially printing the ceramic green body from bottom to top until a completed ceramic green body is obtained;
step 5: removing a water-soluble support material on a surface of the ceramic green body; and
step 6: sintering the ceramic green body to obtain a finished ceramic component.

2. The method for layer-by-layer inkjet printing of the ceramic material according to claim 1, wherein a single scale-like protrusion in the scale-like structure has a length of about 50 μm, a width of about 40 μm, and a height of about 20 μm.

3. The method for layer-by-layer inkjet printing of the ceramic material according to claim 1, wherein the step 5 specifically comprises:
soaking the ceramic green body in pure water for 1 hour to remove the water-soluble support material, and performing natural drying after standing in air for 3 hours.

4. An apparatus for implementing the method for layer-by-layer inkjet printing of the ceramic material according to claim 1, comprising a main mounting frame, wherein a two-dimensional motion platform is disposed at a lower part of the main mounting frame in an axial direction, and an upper part of the main mounting frame is provided with an inkjet printing module, a heating lamp module, a detection module, and a laser module that are sequentially arranged in the axial direction, further comprising a host computer configured to regulate and control the two-dimensional motion platform, the inkjet printing module, the heating lamp module, the detection module, and the laser module.

5. The apparatus according to claim 4, wherein a workbench is disposed at a top of the two-dimensional motion platform, the workbench comprises a bracket, the bracket is fixedly connected to the two-dimensional motion platform, and a heat insulation layer and a manufacturing substrate are disposed at a top of the bracket.

6. The apparatus according to claim 4, wherein the inkjet printing module comprises a motion Y-axis mounting frame fixedly connected to the main mounting frame, a motion Y-axis hanging basket slidably connected to the motion Y-axis mounting frame is disposed below the motion Y-axis mounting frame, and the motion Y-axis hanging basket is provided with an inkjet printhead.

7. The apparatus according to claim 4, wherein the heating lamp module comprises a heating lamp mounting frame fixedly connected to the main mounting frame, and a heating lamp is disposed on the heating lamp mounting frame.

8. The apparatus according to claim 4, wherein the detection module comprises a detection head mounting frame fixedly connected to the main mounting frame, and a laser triangulation detection head is disposed on the detection head mounting frame, and is connected to the host computer through an external signal processing module.

9. The apparatus according to claim 4, wherein the laser module comprises a galvanometer mounting frame fixedly connected to the main mounting frame, a galvanometer is disposed on the galvanometer mounting frame, and a light inlet of the galvanometer communicates with the external optical path and is connected to the host computer through an external processing module.
